(19) United States
(12) Patent Application Publication
(10) Pub. No.: US 2004/0148405 A1
(43) Pub. Date: Jul. 29, 2004

(54) Network connection device, communication system, communication method, communication program, and recording medium

(76) Inventor: Shinji Nakamoto, Yokohama-shi (JP)

Correspondence Address: PEARNE & GORDON LLP, 1801 EAST 9TH STREET, SUITE 1200, CLEVELAND, OH, 44114-3108, US

(21) Appl. No.: 10/478,086

(22) PCT Filed: Jun. 6, 2002
(86) PCT No.: PCT/JP02/05619

(30) Foreign Application Priority Data
Sep. 14, 2001 (JP) 2001-280068

(51) Int. Cl. H04M 11/00; H04L 12/56; H04M 3/00

(52) U.S. Cl. 709/228; 709/245; 709/242

(57) ABSTRACT

When a call is issued from a first analog telephone set (101S) to a second analog telephone set (101R) by utilizing a public telephone line network (107), a second Internet connecting device (103R) senses an incoming call, then stores a telephone number of the first analog telephone set (101S), and then sends out a sender-side telephone number and a receiver-side telephone number as an IP packet to the Internet (105) to direct to a predetermined multicast address. A first Internet connecting device (103S) disconnected the calling when it receives the IP packet, then both Internet connecting devices (103S), (103R) are caused to recognize sender-side and receiver-side IP addresses by transmitting the IP packet to a destination-side IP address via the Internet (105), and thus a voice talking via the Internet (105) is established. Accordingly, the Internet phone system can be built up with a simpler means structure and also a voice quality can be maintained.

### TECHNICAL FIELD

The present invention relates to a network connecting device, a communication system, a communication method, a communication program used to cause the communication method to execute, and a recording medium for recording the communication program and, more particularly, a network connecting device, a communication system, a communication method, a communication program, and a recording medium, which are capable of building up an Internet telephone system with a simple means structure at a low communication cost and also capable of maintaining the voice quality during the talking.

### BACKGROUND ART

With the progress of the Internet application technology in recent years, the application such as the Internet phone (IP phone) through which the analog voice is transmitted onto the digital network was proposed. In this Internet phone, the voice is converted into digital data and then such digital data are transmitted/received via the Internet or the intranet based on the Internet protocol (IP).

The Internet phone is such an application that makes it possible to talk between the personal computers or the phones via the Internet or LAN, based on the VoIP (voice over IP) technology used to pass the voice over the IP network. Thus, if the traffics of the data and the voice are integrated based on the IP or if the trunk lines to the long-distance pivotal points such as the overseas pivotal points, or the like are substituted for the Internet, the communication charges can be suppressed.

The basic communication modes of the Internet phone are classified roughly into two types, i.e., (1) the communication that is implemented by the IP network only and (2) the communication that is implemented by connecting mutually the IP network and the subscriber telephone line network.

One of major application modes of (1) is the “PC-to-PC type” in which the users can talk to each other via the Internet by using the client software for the personal computer. Also, there is the “Phone-to-Phone type” in which both the sending party and the receiving party utilize the normal telephone set. For example, there is the case that the users connect the phones to the Internet from plural pivotal points and then they talk to each other via the VoIP gateways provided to respective pivotal points. In addition, there is the “PC-to-Phone type” in which the user calls the destination phone from the personal computer via the Internet.

In contrast, there are the “PC-to-Phone type” and the “Phone-to-Phone type” as the communication modes of (2). In both types, the communication is carried out between the IP network and the subscriber telephone line network via the gateway units. The service utilizing this communication is the Internet phone service that is provided by the communication enterprise. The users connect the lines to the Internet via the subscriber telephone line network on both the sending side and the receiving side, and then talk to each other via the gateway units.

As the main elemental technologies applied to implement the Internet phone, there are the coding technology for converting the analog voice into the digital data, the packetting technology for formulating such data into the IP packets and sending out such packets to the Internet, the call controlling technology for connecting the virtual communication line to the destination by using the IP address, etc. The standard specification prepared by unifying these technologies is H.323 protocol.

In order to achieve the operability and the convenience both are peculiar to the Internet phone and are close to the telephone, the call controlling technology is required. In the small size Internet phone, normally the VoIP gateway or the client holds the correspondence table between the telephone numbers and the IP addresses and then converts the telephone number into the IP address. More particularly, when the telephone number is dialed by the telephone set on the sending side, the VoIP gateway connects automatically the line to the IP address of the VoIP gateway that connects the line to the destination. In contrast, in the case of the Internet phone service that has a large number of clients and is provided by the enterprise or the provider, unitary management/employment of the telephone number and the IP address are executed by providing the gatekeeper.

However, in the above Internet phone in the prior art, since equipments such as the VoIP gateway, the gatekeeper, etc. must be provided to implement the Internet phone system. For this reason, means for making it possible to build up the Internet phone system at a lower cost are desired.

Also, the biggest problems caused when the voice is transmitted via the packet switching network are a delay time of the packet that is transferred while repeating the store and forward, and its variation. Though there is the progress that the delay time of the packet is reduced according to increase in the speed of the trunk line of the Internet to contribute the practical implementation of the VoIP in recent years, circumstances such that interruption or omission of the conversation or reduction in the voice quality is caused according to the situation is the unsolved subject yet.

### DISCLOSURE OF THE INVENTION

The present invention has been made in view of the above circumstances in the prior art and it is an object of the present invention to provide a network connecting device, a communication system, a communication method, a communication program, and a recording medium, which are capable of building up an Internet telephone system with a simple means structure and also capable of maintaining the voice quality during the talking.

In order to overcome the above subject, there is provided a network connecting device set forth in claim 1 of the present invention connected to a public telephone line network and a second network to control a talking connection executed between a telephone set belonging to the network connecting device and another telephone set belonging to another network connecting device via the public telephone line network or the second network, which comprises an own-side telephone number storing means for storing a telephone number of the telephone set belonging to the network connecting device; a destination-side telephone number storing means for saving a telephone number of a destination-side telephone set when a dialing signal is issued by the telephone set belonging to the network connecting device utilizing the public telephone line network or when an incoming call issued from another telephone set belonging to another network connecting device is sensed; a broadcast controlling means for broadcasting a first data block, which contains a predetermined broadcast address as a receiver address, a network address of the network connecting device as a sender address, and telephone numbers saved in the own-side telephone number storing means and the destination-side telephone number storing means as data, to the second network when the incoming call issued from another telephone set belonging to another network connecting device is sensed; a first reception controlling means for receiving the first data block being broadcasted from another network connecting device after the dialing signal is issued by utilizing the public telephone line network, and then comparing the telephone number in the first data block with the telephone numbers saved in the own-side telephone number storing means and the destination-side telephone number storing means respectively; a destination-side network address storing means for saving the sender address in the first data block when both telephone numbers coincide with each other respectively in comparison executed by the first reception controlling means; a second transmission controlling means for transmitting a second data block, which contains an address saved in the destination-side network address storing means as the receiver address, a network address of the network connecting device as the sender address, and the telephone numbers saved in the own-side telephone number storing means and the destination-side telephone number storing means as data, to the second network and also releasing the public telephone line network that is now called when both telephone numbers coincide with each other in comparison executed by the first reception controlling means; a second reception controlling means for receiving a data block transmitted from another network connecting device after broadcast is executed by the broadcast controlling means or after transmission is executed by the second transmission controlling means, and then comparing the telephone number in the data bock with the telephone numbers saved in the own-side telephone number storing means and the destination-side telephone number storing means respectively; and a third transmission controlling means for transmitting a data block, which contains an address saved in the destination-side network address storing means as the receiver address, a network address of the network connecting device as the sender address, and the telephone numbers saved in the own-side telephone number storing means and the destination-side telephone number storing means and voice data as data, to the second network when both telephone numbers coincide with each other respectively in comparison executed by the second reception controlling means.

Also, in the network connecting device according to claim 1, in the network connecting device set forth in claim 2, the data block being transmitted from the third transmission controlling means contains a number that is assigned in order of transmission, and the network connecting device set forth in claim 2 further comprises a first switching controlling means for counting a piece number of a serial number of the data block received within a predetermined time at a time of voice talking utilizing the second network, and then the voice talking is switched into a voice talking utilizing the public telephone line network when a counted number is smaller than a predetermined value.

Also, in the network connecting device according to claim 2, the network connecting device set forth in claim 3 further comprises a fourth transmission controlling means for transmitting periodically a third data block, which contains the address saved in the destination-side network address storing means as the receiver address, the network address of the network connecting device as the sender address, and the number being assigned in order of transmission as data, to the second network after the voice talking is switched from the voice talking utilizing the second network into the voice talking utilizing the public telephone line network by the first switching controlling means; and a second switching controlling means for receiving the third data block being transmitted periodically from the fourth transmission controlling means in another network connecting device, then counting the piece number of the serial number of the third data block received within a predetermined time, and then switching. the voice talking into the voice talking utilizing the second network if a counted number is in excess of a predetermined value.

Also, there is provided a communication system set forth in claim 4 of the present invention which comprises a first network connecting device and a second network connecting device connected to a public telephone line network and a second network; a first telephone set belonging to the first network connecting device; and a second telephone set belonging to the second network; wherein the first network connecting device includes, an own-side telephone number storing means for saving a telephone number of the first telephone set; a destination-side telephone number storing means for saving a telephone number of a destination-side telephone set when a dialing signal is issued by the first telephone set utilizing the public telephone line network; a first reception controlling means for receiving the first data block being broadcasted from the second network connecting device after the dialing signal is issued by utilizing the public telephone line network, and then comparing the telephone number in the first data block with telephone numbers saved in the own-side telephone number storing means and the destination-side telephone number storing means respectively; a destination-side network address storing means for saving a sender address in the first data block when both telephone numbers coincide with each other respectively in comparison executed by the first reception controlling means; a second transmission controlling means for transmitting a second data block, which contains an address saved in the destination-side network address storing means as the receiver address, a network address of the first network connecting device as the sender address, and the telephone numbers saved in the own-side telephone number storing means and the destination-side telephone number storing means as data, to the second network and also releasing the public telephone line network that is now called when both telephone numbers coincide with each other in comparison executed by the first reception controlling means; a second reception controlling means for receiving a data block transmitted from the second network connecting device after transmission is executed by the second transmission controlling means, and then comparing the telephone number in the data bock with the telephone numbers saved in the own-side telephone number storing means and the destination-side telephone number storing means respectively; and a third transmission controlling means for transmitting a data block, which contains an address saved in the destination-side network address storing means as the receiver address, a network address of the first network connecting device as the sender address, and the telephone numbers saved in the own-side telephone number storing means and the destination-side telephone number storing means and voice data as data, to the second network when both telephone numbers coincide with each other respectively in comparison executed by the second reception controlling means; and the second network connecting device includes, an own-side telephone number storing means for saving a telephone number of the second telephone set; a destination-side telephone number storing means for saving a telephone number of the first telephone set when an incoming call issued from the first telephone set belonging to the first network connecting device is sensed; a broadcast controlling means for broadcasting a first data block, which contains a predetermined broadcast address as a receiver address, a network address of the second network connecting device as a sender address, and the telephone numbers saved in the own-side telephone number storing means and the destination-side telephone number storing means as data, to the second network when the incoming call issued from the first telephone set belonging to the first network connecting device is sensed; a second reception controlling means for receiving the data block being transmitted from the first network connecting device after broadcast is executed by the broadcast controlling means, and then comparing the telephone number in the data block with the telephone numbers saved in the own-side telephone number storing means and the destination-side telephone number storing means respectively; a destination-side network address storing means for saving the sender address in the first data block when both telephone numbers coincide with each other respectively in comparison executed by the first reception controlling means; and a third transmission controlling means for transmitting a data block, which contains an address saved in the destination-side network address storing means as the receiver address, a network address of the network connecting device as the sender address, and the telephone numbers saved in the own-side telephone number storing means and the destination-side telephone number storing means and voice data as data, to the second network when both telephone numbers coincide with each other respectively in comparison executed by the second reception controlling means.

Also, there is provided a communication method set froth in claim 5 of the present invention for a communication system having a first network connecting device and a second network connecting device connected to a public telephone line network and a second network, a first telephone set belonging to the first network connecting device, and a second telephone set belonging to the second network, in the first network connecting device, the method comprising an own-side telephone number storing step of storing a telephone number of the first telephone set; a destination-side telephone number storing step of storing a telephone number of a destination-side telephone set when a dialing signal is issued by the first telephone set utilizing the public telephone line network; a first reception controlling step of receiving the first data block being broadcasted from the second network connecting device after the dialing signal is issued by utilizing the public telephone line network, and then comparing the telephone number in the first data block with telephone numbers stored by the own-side telephone number storing step and the destination-side telephone number storing step respectively; a destination-side network address storing step of storing a sender address in the first data block when both telephone numbers coincide with each other respectively in comparison executed by the first reception controlling step; a second transmission controlling step of transmitting a second data block, which contains an address stored by the destination-side network address storing step as the receiver address, a network address of the first network connecting device as the sender address, and the telephone numbers stored by the own-side telephone number storing step and the destination-side telephone number storing step as data, to the second network and also releasing the public telephone line network that is now called when both telephone numbers coincide with each other in comparison executed by the first reception controlling step; a second reception controlling step of receiving a data block transmitted from the second network connecting device after transmission is executed by the second transmission controlling step, and then comparing the telephone number in the data bock with the telephone numbers stored by the own-side telephone number storing step and the destination-side telephone number storing step respectively; and a third transmission controlling step of transmitting a data block, which contains an address stored by the destination-side network address storing step as the receiver address, a network address of the first network connecting device as the sender address, and the telephone numbers stored by the own-side telephone number storing step and the destination-side telephone number storing step and voice data as data, to the second network when both telephone numbers coincide with each other respectively in comparison executed by the second reception controlling step; and in the second network connecting device, the method comprising an own-side telephone number storing step of storing a telephone number of the second telephone set; a destination-side telephone number storing step of storing a telephone number of the first telephone set when an incoming call issued from the first telephone set belonging to the first network connecting device is sensed; a broadcast controlling step of broadcasting a first data block, which contains a predetermined broadcast address as the receiver address, a network address of the second network connecting device as the sender address, and the telephone numbers stored by the own-side telephone number storing step and the destination-side telephone number storing step as data, to the second network when the incoming call issued from the first telephone set belonging to the first network connecting device is sensed; a second reception controlling step of receiving the data block being transmitted from the first network connecting device after broadcast is executed by the broadcast controlling step, and then comparing the telephone number in the data block with the telephone numbers stored by the own-side telephone number storing step and the destination-side telephone number storing step respectively; a destination-side network address storing step of storing the sender address in the data block when both telephone numbers coincide with each other respectively in comparison executed by the second reception controlling step; and a third transmission controlling step of transmitting a data block, which contains an address stored in the destination-side network address storing step as the receiver address, a network address of the second network connecting device as the sender address, and the telephone numbers stored by the own-side telephone number storing step and the destination-side telephone number storing step and the voice data as data, to the second network when both telephone numbers coincide with each other respectively in comparison executed by the second reception controlling step.

Also, a communication program set forth in claim 6 of the present invention used to cause a computer to execute the communication method set forth in claim 5. In addition, a computer-readable recording medium set forth in claim 7 of the present invention for recording the communication method set forth in claim 5 as a program that is used to cause a computer to execute the communication method.

According to the network connecting device set forth in claim 1 of the present invention, the communication system set forth in claim 4, the communication method set forth in claim 5, the communication program set forth in claim 6, and the recording medium set forth in claim 7, in one (first) network connecting device, the telephone number of the own-side (first) analog telephone set is stored by the own-side telephone number storing means (by the own-side telephone number storing step) and also the telephone number of the destination-side (second) analog telephone set is saved by the destination-side telephone number storing means (by the destination-side telephone number storing step) at the time of dial-up by the (first) analog telephone set by utilizing the public telephone line network. In contrast, in the other (second) network connecting device, the telephone number of the own-side (second) analog telephone set is stored by the own-side telephone number storing means (by the own-side telephone number storing step), and also the telephone number of the (first) telephone set is saved by the destination-side telephone number storing means (by the destination-side telephone number storing step) at the time of receiving the call from the (first) telephone set belonging to the (first) network connecting device. Also, the first data block containing the predetermined multicast address as the receiver address, the network address of the (second) network connecting device as the sender address, and the telephone numbers saved in the own-side telephone number storing means and the destination-side telephone number storing means as the data is multicast-transmitted to the second network by the broadcast controlling means (by the broadcast controlling step).

Then, in the (first) network connecting device, the first data block being multicast-transmitted from the other (second) network connecting device by first reception controlling means (by the first reception controlling step) is received after the dialing signal is issued by utilizing the public telephone line network, and then the telephone number in the first data block is compared with the telephone numbers saved in the own-side telephone number storing means and the destination-side telephone number storing means respectively. Then, if both telephone numbers coincide with each other in such comparison, the sender address in the first data block is saved by the destination-side network address storing means (by the destination-side network address storing step). Also, if both telephone numbers coincide with each other in comparison executed by the first reception controlling means (by the first reception controlling step), the second data block containing the address saved in the destination-side network address storing means as the receiver address, the network address of the (first) network connecting device as the sender address, and the telephone numbers saved in the own-side telephone number storing means and the destination-side telephone number storing means as the data is sent out to the second network by the second transmission controlling means (by the second transmission controlling step), and also the public telephone line network that is now called is released.

Next, after the data block is multicast-transmitted from the other (second) network connecting device by the broadcast controlling means (by the broadcast controlling step) or after the data block is transmitted from the (first) network connecting device by the second transmission controlling means (by the second transmission controlling step), the data block transmitted from the network connecting device on the other party is received by the second reception controlling means (by the second reception controlling step), and then the telephone number in the data block is compared with the telephone numbers saved in the own-side telephone number storing means and the destination-side telephone number storing means respectively. Then, if both telephone numbers coincide with each other in such comparison, the data block containing the address saved in the destination-side network address storing means as the receiver address, the network address of the other (second) network connecting device or one (first) network connecting device as the sender address, and the telephone numbers saved in the own-side telephone number storing means and the destination-side telephone number storing means and the voice data as the data is transmitted by the third transmission controlling means (by the third transmission controlling step) to the second network. In this case, in the other (second) network connecting device, if both telephone numbers coincide with each other in such comparison executed by the second reception controlling means (by the second reception controlling step), the sender address in the data block is saved in the destination-side network address storing means (by the destination-side network address storing step).

Subsequently, the data block is transmitted by the third transmission controlling means (by the third transmission controlling step) to execute the voice talking via the second network while checking the telephone number in the received data block by the second reception controlling means (by the second reception controlling step). Here, LAN, WAN, ATM network, the Internet, etc. correspond to the second network, and the network addresses in the second network are assigned to the one (first) network connecting device and the other (second) network connecting device. Also, the data block is formatted as the packet, the frame, the cell, etc. For example, the cell is used in the ATM network, and the IP packet is used in the Internet.

For example, if the Internet is used as the second network, the voice talking via the Internet can be carried out by transmitting/receiving the IP packet by virtue of the xDSL communication using the TCP/IP protocol, and thus the Internet phone system can be implemented. In the prior art, in order to build up the Internet phone system that can reduce further the communication cost, provision of equipments such as the VoIP gateway, the gatekeeper, etc. is needed. But these equipments are not needed in the present invention, and thus the low-cost Internet phone system can be built up with a simpler means construction.

Also, in the network connecting device according to claim 2, the number assigned in order of transmission is contained in the data block being transmitted by the third transmission controlling means. In one (first) network connecting device and the other (second) network connecting device, the piece number of the serial number of the data blocks received within the predetermined time is counted by the first switching controlling means during when the voice talking utilizing the second network is carried out. Then, if the counted number is smaller than a predetermined value, the voice talking is switched into the voice talking utilizing the public telephone line network.

In this manner, in the voice talking utilizing the second network, the deterioration of the voice quality is decided by the number of the data blocks being received within the predetermined time, and then such voice talking utilizing the second network is switched automatically into the voice talking by utilizing the public telephone line network if the voice quality is deteriorated. Therefore, even if the voice quality is lowered, e.g., the conversation is disconnected, omitted, etc. according to the situation, the voice quality in the talking can be maintained by switching the voice talking into the normal voice talking utilizing the public telephone line network.

Also, in the network connecting device according to claim 3, in one (first) network connecting device and the other (second) network connecting device, after the voice talking is switched from the voice talking utilizing the second network to the voice talking utilizing the public telephone line network by the first switching controlling means, and then the third data block containing the address saved in the destination-side network address storing means as the receiver address, the network address of one (first) network connecting device or the other (second) network connecting device as the sender address, and the number being assigned in order of transmission as the data is transmitted periodically to the second network by the fourth transmission controlling means. In the other (second) network connecting device or one (first) network connecting device, the third data block being transmitted periodically from the fourth transmission controlling means of the destination-side network connecting device is received by the second switching controlling means, then the piece number of the serial number of the third data blocks is counted within the predetermined time, and then the voice talking is switched into the voice talking utilizing the second network if the counted number is in excess of the predetermined value.

In this manner, after the voice talking is switched into the voice talking utilizing the public telephone line network, the quality checking data block is transmitted/received periodically, and then improvement of the voice quality in the second network is decided based on the number of the data blocks received within the predetermined time. Then, if it is decided that the voice quality is improved, the voice talking is switched automatically into the voice talking utilizing the second network. Therefore, the voice talking utilizing the second network, which has a lower communication cost, can be carried out preferentially while maintaining the voice quality in the taking.

### BRIEF DESCRIPTION OF THE DRAWINGS

FIG. 1 is a configurative view of a communication system according to an embodiment of the present invention.

FIG. 2 is a configurative view of a network connecting device according to an embodiment of the present invention.

FIG. 3 is an explanatory view explaining establishment of a talking via the Internet.

FIG. 4 is an explanatory view explaining a voice talking via the Internet.

FIG. 5 is an explanatory view explaining disconnection of the voice talking via the Internet.

FIG. 6 is an explanatory view explaining switching the voice talking from the voice talking via the Internet to a normal talking via a public telephone line network, which is initiated by the sending party.

FIG. 7 is an explanatory view explaining switching the voice talking from the normal talking via a public telephone line network to the voice talking via the Internet, which is initiated by the sending party.

FIG. 8 is an explanatory view explaining the switching the voice talking from the voice talking via the Internet to the normal talking via the public telephone line network, which is initiated by the receiving party.

FIG. 9 is an explanatory view explaining the switching the voice talking from the normal talking via the public telephone line network to the voice talking via the Internet, which is initiated by the receiving party.

In above Figures, a reference numeral 101S refers to a first analog telephone set, 101R to a second analog telephone set, 103S to a first Internet connecting device, 103R to a second Internet connecting device, 105 to the Internet (second network), 107 to a public telephone line network, 201 to an analog telephone interface portion, 203 to a xDSL modem interface portion, 205 to a public telephone line network interface portion, 207 to an A/D•D/A voice processing portion, 209 is an IP packet processing portion, 211 to an Internet talking quality checking portion, 213 to a DTMF signal sensing•generating/modem signal demodulating portion, 215 to a timer portion, 217 to an own-side IP address storing portion, 219 to a destination-side IP address storing portion, 221 to an own-side telephone number storing portion, 223 to a destination-side telephone number storing portion, and 225 to an overall controlling portion.

### BEST MODE FOR CARRYING OUT THE INVENTION

Embodiments of a network connecting device, a communication system, a communication method, a communication program, and a recording medium of the present invention will be explained in detail with reference to the drawings hereinafter. Here, in the explanation of respective embodiments, the network connecting device, the communication system, and the communication method according to the present invention will be explained in detail. In this case, since the communication program according to the present invention is a communication program for executing the communication method and also the recording medium according to the present invention is a recording medium for recording the program used to cause the communication method to execute, it should be interpreted that their explanations are contained in the explanation about the communication method given in the following.

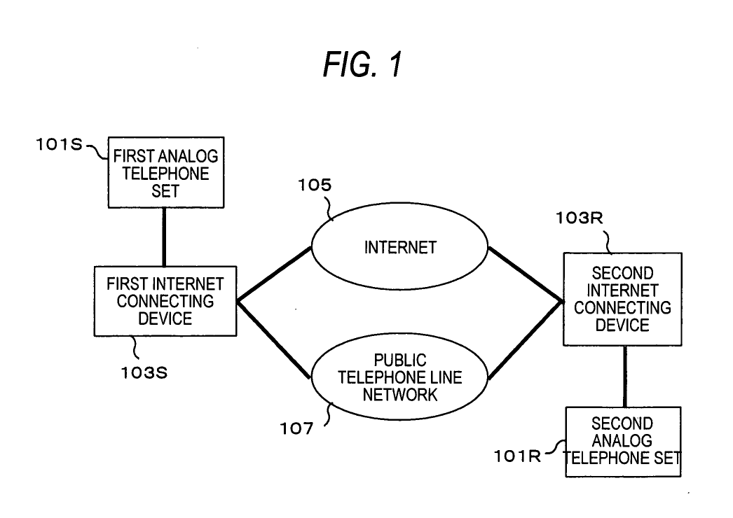

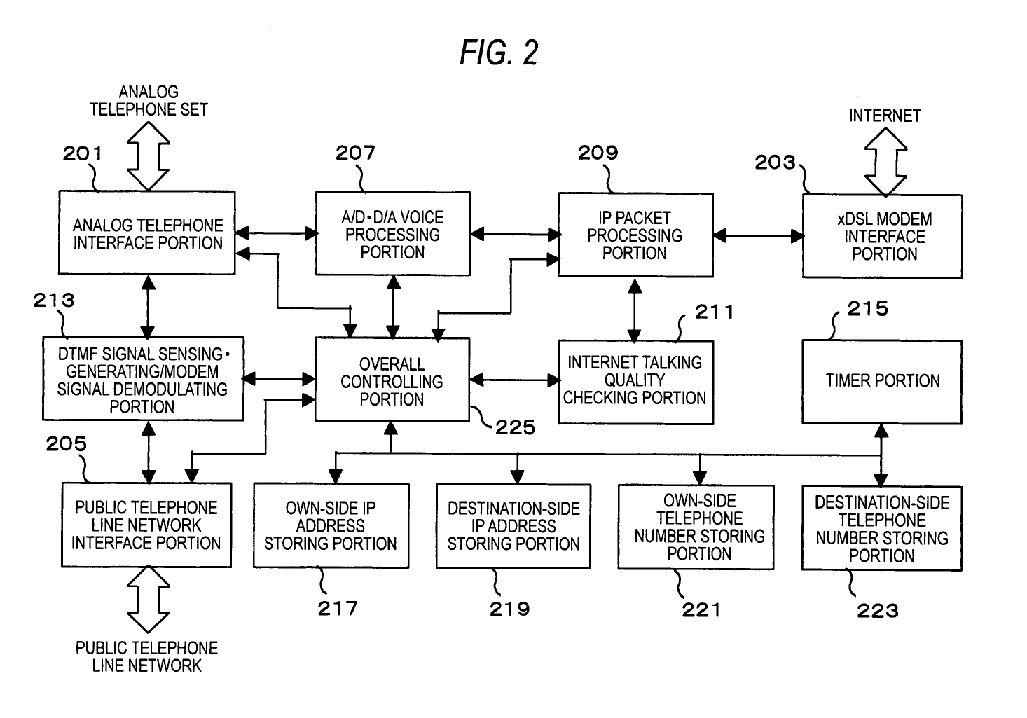

FIG. 1 is a configurative view of the communication system according to an embodiment of the present invention. FIG. 2 is a configurative view of the network connecting device according to an embodiment of the present invention.

First, in FIG. 1, the communication system according to the present embodiment is constructed to have a public telephone line network 107, the Internet 105 as a second network, a first analog telephone set 101S and a second analog telephone set 101R as a voice inputting/outputting means used to execute the talking, a first Internet connecting device 103S for connecting the first analog telephone set 101S to the public telephone line network 107 and the Internet 105, and a second Internet connecting device 103R for connecting the second analog telephone set 101R to the public telephone line network 107 and the Internet 105.

In this case, the first Internet connecting device 103S and the second Internet connecting device 103R have the same configuration. In the following description, in order to make the explanation easy to understand, such explanation will be made under the assumption that the first analog telephone set 101S (first Internet connecting device 103S) is set to the sending party and the second analog telephone set 101R (second Internet connecting device 103R) is set to the receiving party, if not particularly mentioned.

Also, in FIG. 2, the network connecting device according to the present embodiment, i.e., the first Internet connecting device 103S or the second Internet connecting device 103R, is constructed to have an analog telephone interface portion 201, an xDSL modem interface portion 203, a public telephone line network interface portion 205, an A/D•D/A voice processing portion 207, an IP packet processing portion 209, an Internet talking quality checking portion 211, a DTMF signal sensing•generating/modem signal demodulating portion 213, a timer portion 215, an own-side IP address storing portion 217, a destination-side IP address storing portion 219, an own-side telephone number storing portion 221, a destination-side telephone number storing portion 223, and an overall controlling portion 225.

In this case, functional explanations of respective constituent elements of the first Internet connecting device 103S that is connected to the first analog telephone set 101S will be made hereinafter. These are similarly true of the second Internet connecting device 103R.

First, the analog telephone interface portion 201 acts as the interface between the first Internet connecting device 103S and the first analog telephone set 101S. Also, the xDSL modem interface portion 203 acts as the interface to an xDSL modem that is provided to the outside to get the connection to the Internet 105. Also, the public telephone line network interface portion 205 acts as the interface to the public telephone line network 107. In this case, “xDSL (x Digital Subscriber Line)” of the xDSL modem interface portion 203 means a generic name of the high-speed digital transmission system that employs the telephone copper cable (subscriber line). For example, HDSL (High bit rate DSL), SDSL (Symmetric DSL), ADSL (Asymmetric DSL), VDSL (Very high bit rate DSL), etc. correspond to such line. Also, in the xDSL, the data are transmitted by using the bandwidth up to the high frequency band of several MHz and thus the high-speed communication can be implemented by interposing the xDSL modem.

Then, the A/D•D/A voice processing portion 207 A/D-converts the analog voice signal from the first analog telephone set 101S and then converts the digital signal into compressed voice signal data, and also expands the compressed voice signal data in the IP packet and then D/A-converts the digital signal into the original analog voice signal.

Also, the IP packet processing portion 209 loads the compressed voice signal data, which are received from the A/D•D/A voice processing portion 207, into the IP packet and then sends out such IP packet to the Internet 105 via the xDSL modem interface portion 203, and also unloads the voice signal data from the IP packet supplied from the Internet 105 and then transfers such voice signal data to the A/D•D/A voice processing portion 207.

Also, the timer portion 215 measures a predetermined time interval. The Internet talking quality checking portion 211 counts sequentially the piece number of the serial number of the IP packets that the first Internet connecting device 103S receives within the predetermined time interval measured by the timer portion 215, and then decides the voice quality of the voice talking via the Internet 105. In this case, at the time of the voice talking via the Internet 105, the number is assigned to the IP packet in order of transmission when the voice signal is formatted into the IP packet by the IP packet processing portion 209. Thus, the Internet talking quality checking portion 211 decides such voice quality based on this number. In other words, it is decided that, if the piece number of the serial number of the IP packets received within the predetermined time interval is smaller than a predetermined number, the voice quality is deteriorated, while it is decided that, if the piece number of the serial number of the IP packets is larger than the predetermined number, the voice quality is recovered.

Also, the DTMF signal sensing•generating/modem signal demodulating portion 213 demodulates the DTMF (Dual Tone Multi-Frequency) signal that is supplied from the first analog telephone set 101S via the analog telephone interface portion 201, or the modem signal that is supplied from the public telephone line network 107 via the public telephone line network interface portion 205. The receiver-side telephone number (i.e., the telephone number of the second analog telephone set 101R) is recognized at the time of issuing the call. The sender-side telephone number (i.e., the telephone number of the first analog telephone set 101S) is recognized at the time of receiving the call.

In addition, the IP address of the first Internet connecting device 103S is stored previously in the own-side IP address storing portion 217. The telephone number of the first analog telephone set 101S that is connected to the first Internet connecting device 103S is stored previously in the own-side telephone number storing portion 221. Also, when the call issued from another analog telephone set is received via the public telephone line network 107, the telephone number of the analog telephone set that issued such call is stored in the destination-side telephone number storing portion 223. In addition, when the IP packet issued from another Internet connecting device is received via the Internet 105, the IP address of the Internet connecting device that transmits such IP packet is stored in the destination-side IP address storing portion 219.

In this case, a broadcast controlling means, a first reception controlling means, a second transmission controlling means, a second reception controlling means, and a third transmission controlling means set forth in claims are implemented by the xDSL modem interface portion 203, the IP packet processing portion 209, and the overall controlling portion 225. Also, a first switching controlling means, a fourth transmission controlling means, and a second switching controlling means are implemented by the xDSL modem interface portion 203, the IP packet processing portion 209, the Internet talking quality checking portion 211, the timer portion 215, and the overall controlling portion 225.

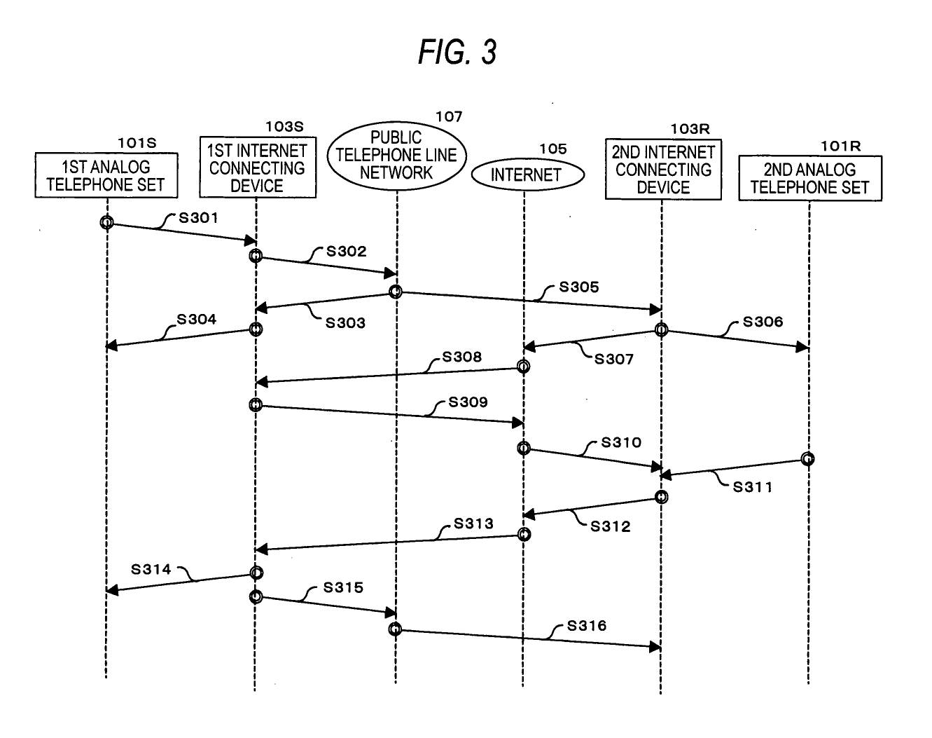

Next, a communication method applied to execute the voice talking between the analog telephone sets (the first analog telephone set 101S and the second analog telephone set 101R in FIG. 1) connected to the Internet connecting devices (the first Internet connecting device 103S and the second Internet connecting device 103R in FIG. 1) having the above constituent elements will be explained in detail with reference to FIG. 3 to FIG. 9 hereunder.

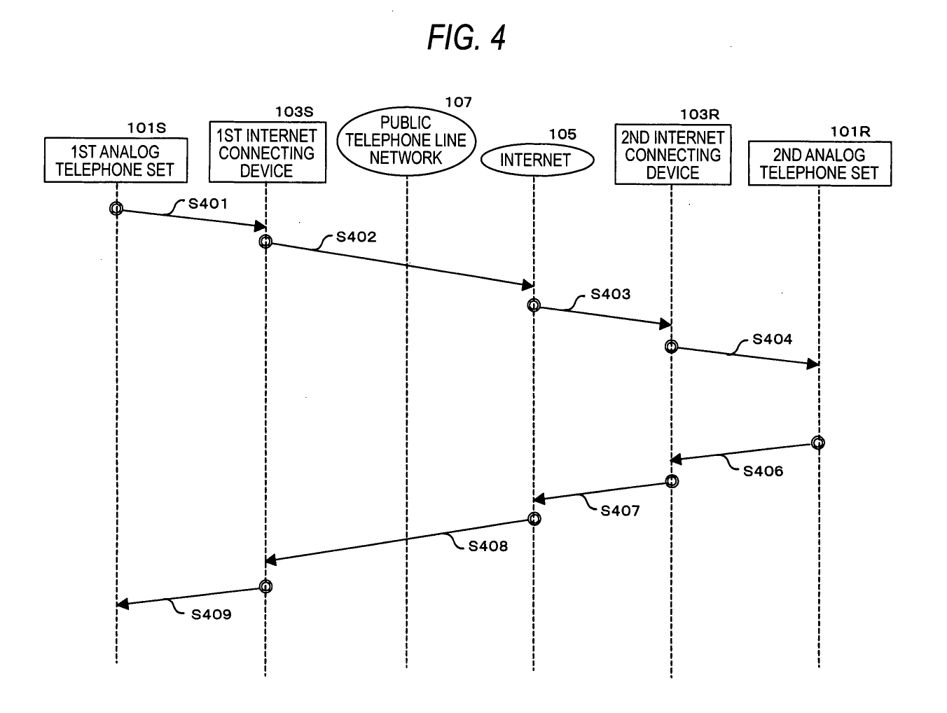

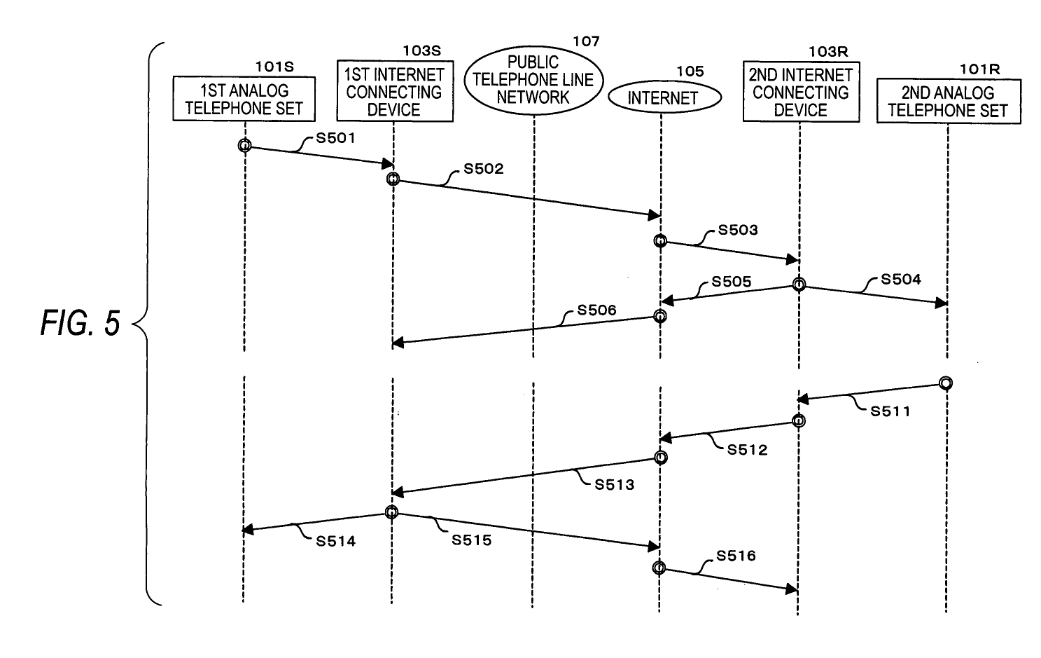

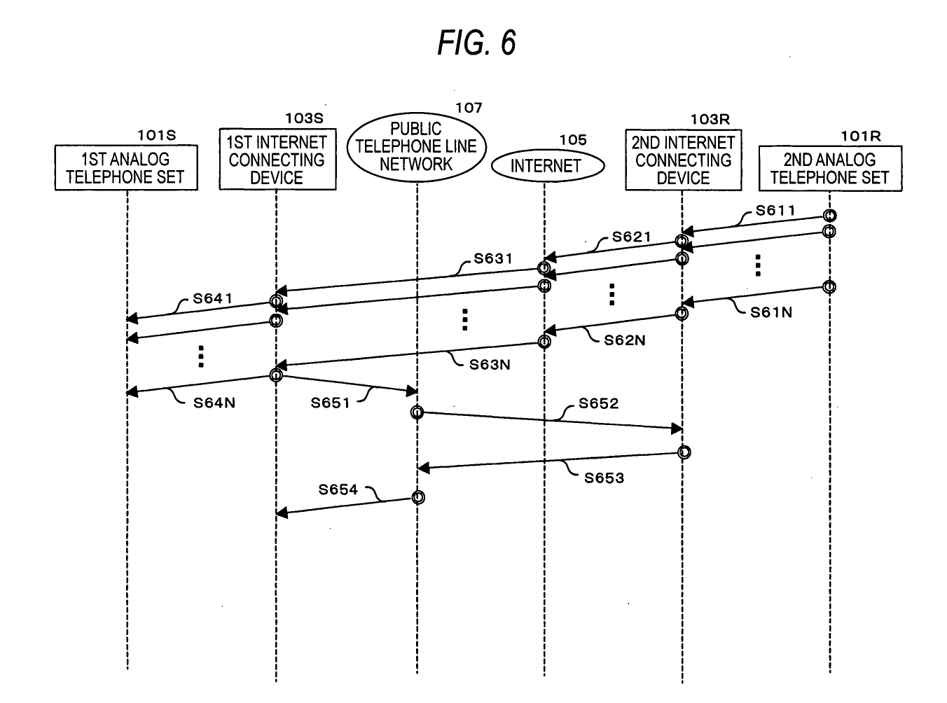

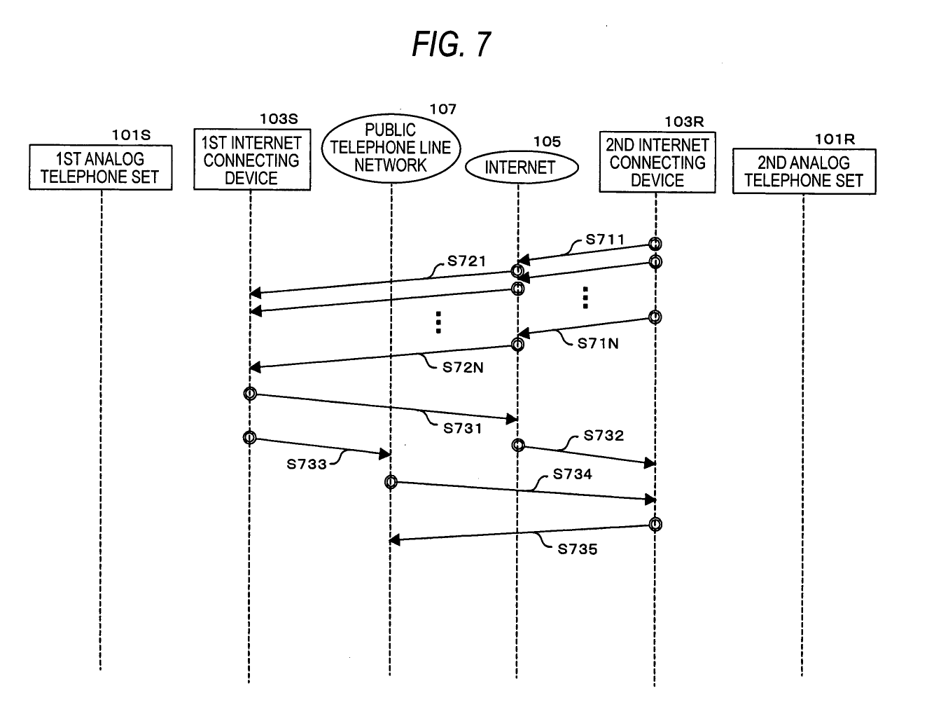

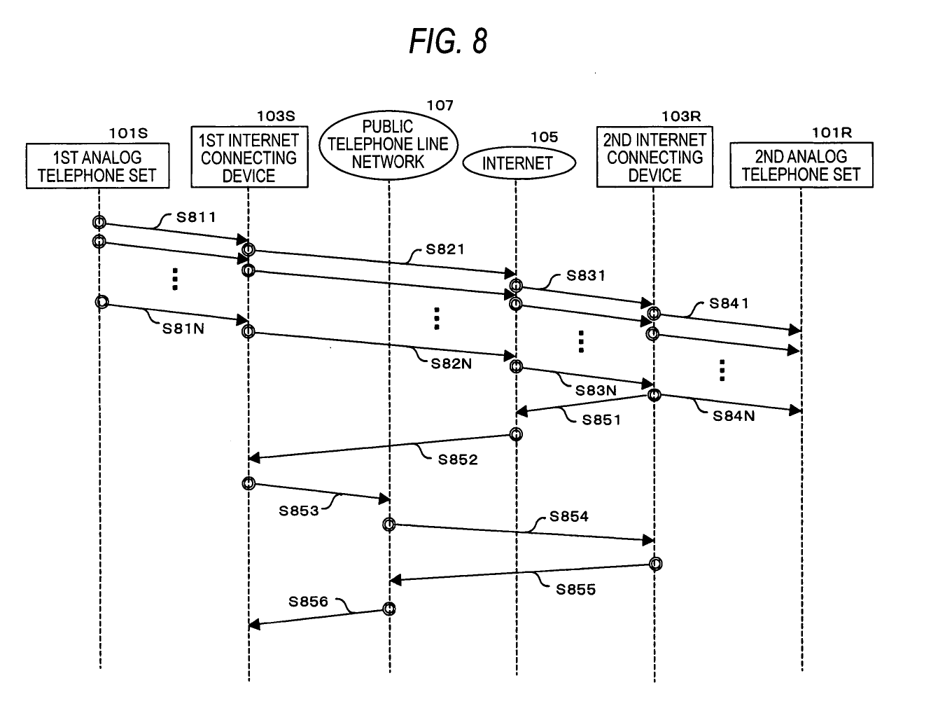

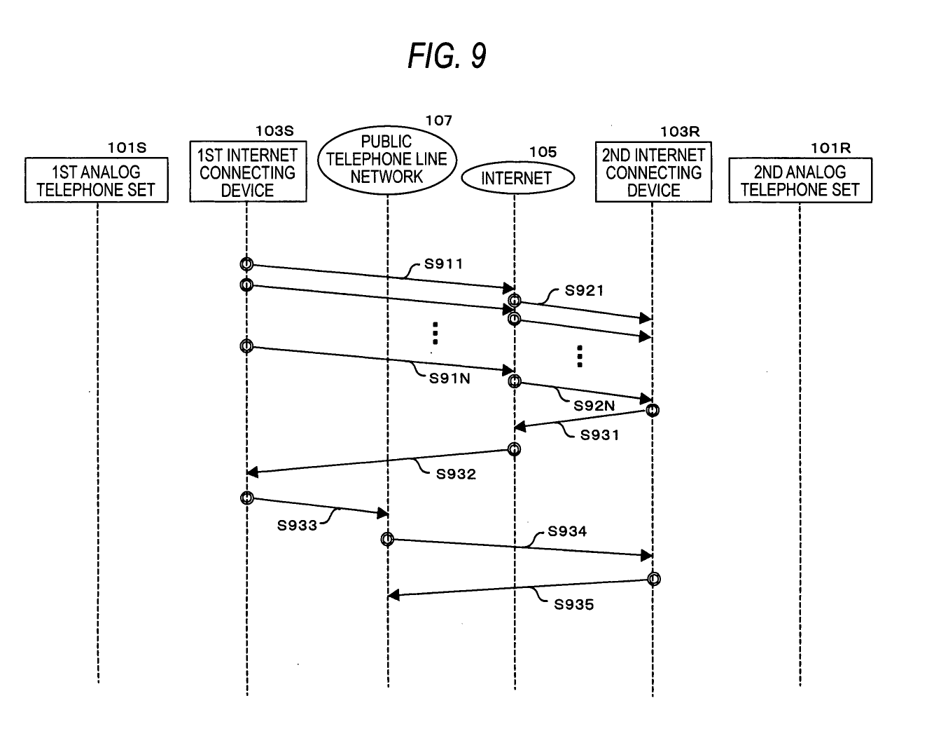

Here, FIG. 3 to FIG. 9 are explanatory views explaining the communication method based on sequences. FIG. 3 is an explanatory view explaining establishment of the talking via the Internet 105. FIG. 4 is an explanatory view explaining the voice talking via the Internet 105. FIG. 5 is an explanatory view explaining disconnection of the voice talking via the Internet 105. FIG. 6 is an explanatory view explaining switching from the voice talking via the Internet 105 to the normal talking via the public telephone line network 107, which is initiated by the sending party. FIG. 7 is an explanatory view explaining switching from the normal talking via the public telephone line network 107 to the voice talking via the Internet 105, which is initiated by the sending party. FIG. 8 is an explanatory view explaining the switching from the voice talking via the Internet 105 to the normal talking via the public telephone line network 107, which is initiated by the receiving party. FIG. 9 is an explanatory view explaining the switching from the normal talking via the public telephone line network 107 to the voice talking via the Internet 105, which is initiated by the receiving party.

First, procedures required until the talking via the Internet 105 is established will be explained with reference to FIG. 3 hereunder. In step S301, the receiving-side telephone number (the telephone number of the second analog telephone set 101R) is dialed from the first analog telephone set 101S. Here, the dialing signal is assumed as the push-button tone signal (DTMF signal).

Then, in step S302, the receiving-side telephone number is dialed to the public telephone line network 107 by the first Internet connecting device 103S in response to the call issued from the first analog telephone set 101S. More particularly, the DTMF signal sensing•generating/modem signal demodulating portion 213 recognizes the receiving-side telephone number based on the dialing signal that is received via the analog telephone interface portion 201, then saves such receiving-side telephone number in the destination-side telephone number storing portion 223 under control of the overall controlling portion 225, and then sends out the dialing signal to the public telephone line network 107 via the public telephone line network interface portion 205.

Then, in step S303, the ringing tone is sent out to the first Internet connecting device 103S on the sending party from the public telephone line network 107. In step S304, the first Internet connecting device 103S sends out the ringing tone supplied from the public telephone line network 107 to the first analog telephone set 101S. More particularly, the ringing tone is transmitted to the first analog telephone set 101S via the public telephone line network interface portion 205, the DTMF signal sensing•generating/modem signal demodulating portion 213, and the analog telephone interface portion 201 in the first Internet connecting device 103S. Thus, the ringing tone is heard from the earpiece of the first analog telephone set 101S.

Then, in step S305, the modem signal is received by the second Internet connecting device 103R on the receiving party via the public telephone line network 107. At this time, in the second Internet connecting device 103R, the modem signal supplied from the public telephone line network 107 is received via the public telephone line network interface portion 205. Then, such modem signal is demodulated by the DTMF signal sensing•generating/modem signal demodulating portion 213 to recognize the telephone number on the sending party. Then, such telephone number is saved in the destination-side telephone number storing portion 223 under control of the overall controlling portion 225.

Then, in step S306, in the second Internet connecting device 103R, the ringing tone supplied from the public telephone line network 107 is transmitted to the second analog telephone set 101R as the ringing tone as it is via the public telephone line network interface portion 205, the DTMF signal sensing•generating/modem signal demodulating portion 213, and the analog telephone interface portion 201. Thus, a loudspeaker of the second analog telephone set 101R sounds the ringing tone.

Then, in step S307, in the second Internet connecting device 103R, a multicast address being determined previously as the receiver address, the IP address of the second Internet connecting device 103R on the receiving party as the sender address, and the sending-party telephone number and the receiving-party telephone number as the IP packet data are formatted into the IP packet by the IP packet processing portion 209. Then, such IP packet is sent out to the Internet 105 via the xDSL modem interface portion 203. This step S307 gives a function of the broadcast controlling means set forth in claims, and corresponds to a broadcast controlling step.

Here, the multicast address means an address that is used to broadcast the data to a plurality of Internet connecting devices, which have a group of previously set IP addresses, among the Internet connecting device group connected to the Internet 105, and is saved in other storing portion not shown in FIG. 2. Also, the address saved in the own-side IP address storing portion 217, the telephone number saved in the destination-side telephone number storing portion 223, and the telephone number saved in the own-side telephone number storing portion 221 are used as the receiving-party IP address, the sending-party telephone number, and the receiving-party telephone number respectively.

Then, in step S308, in the first Internet connecting device. 103S on the sending party, the IP packet that is broadcasted as the multicast via the Internet 105 is received, then comparison between the currently calling telephone number and the receiving-party telephone number in the data portion of the IP packet and comparison between the sending-party telephone number and the sending-party telephone number in the data portion of the IP packet are executed, then the sender address of the received IP packet is recognized as the IP address of the second Internet connecting device 103R on the receiving party if these telephone numbers coincide with each other respectively. This step S308 gives a function of the first reception controlling means set forth in claims, and corresponds to a first reception controlling step.

More particularly, the sending-party telephone number and the receiving-party telephone number are extracted from the data portion of the received IP packet, then these telephone numbers are compared with the telephone numbers stored in the own-side telephone number storing portion 221 and the destination-side telephone number storing portion 223 respectively, and then the sender address of the received IP packet is saved in the destination-side IP address storing portion 219 as the IP address on the receiving party under control of the overall controlling portion 225 if these telephone numbers coincide with each other respectively.

Then, in step S309, in the first Internet connecting device 103S, the IP address of the second Internet connecting device 103R on the receiving party obtained in step S308 as the receiver address, the IP address of the first Internet connecting device 103S on the sending party as the sender address, and the sending-party telephone number and the receiving-party telephone number as the IP packet data are formatted into the IP packet by the IP packet processing portion 209. Then, such IP packet is sent out to the Internet 105 via the xDSL modem interface portion 203. This step S309 is a part of a function of the second transmission controlling means set forth in claims, and corresponds to a part of a second transmission controlling step.

Here, the address saved in the destination-side IP address storing portion 219, the address saved in the own-side IP address storing portion 217, the telephone number saved in the own-side telephone number storing portion 221, and the telephone number saved in the destination-side telephone number storing portion 223 are used as the receiver address, the sending-party IP address, the sending-party telephone number, and the receiving-party telephone number respectively.

Then, in step S310, in the second Internet connecting device 103R on the receiving party, the IP packet transmitted to the own side via the Internet 105 is received, then the sending-party telephone number and the receiving-party telephone number in the data portion of the IP packet are compared with the telephone numbers stored in the destination-side telephone number storing portion 223 and the own-side telephone number storing portion 221 respectively, and then the sender address of the received IP packet is saved in the own-side IP address storing portion 217 as the IP address of the first Internet connecting device 103S on the sending party under control of the overall controlling portion 225 if these telephone numbers coincide with each other respectively. This step S310 gives a function of the second reception controlling means set forth in claims, and corresponds to a second reception controlling step.

Subsequently to this, in the first Internet connecting device 103S on the sending party and the second Internet connecting device 103R on the receiving party, the sending-party telephone number and the receiving-party telephone number are loaded on the data portion of the to-be-transmitted IP packet, and then it is always checked on the receiving party whether or not the received IP packet is transmitted from the person on the other end of the line, by comparing the own-side telephone number storing portion 221 and the destination-side telephone number storing portion 223.

Then, in step S311, in the second analog telephone set 101R on the receiving party, when such telephone set 101R is taken off the hook, the answer signal is sent out to the second Internet connecting device 103R. The second Internet connecting device 103R receives the answer signal via the analog telephone interface portion 201, and the overall controlling portion 225 recognizes that the second analog telephone set 101R is taken off the hook.

Then, in step S312, in the second Internet connecting device 103R on the receiving party, in order to transmit the IP packet to the other party of the talking, the IP address of the first Internet connecting device 103S on the sending party obtained in step S310 (saved in the destination-side IP address storing portion 219) as the receiver address, the IP address of the second Internet connecting device 103R (saved in the own-side IP address storing portion 217) as the sender address, and the predetermined Internet talking answer signal data as the data portion are incorporated respectively by the IP packet processing portion 209 to formulate the IP packet, and then such IP packet is sent out to the Internet 105 via the xDSL modem interface portion 203. This step S312 gives a function of the third transmission controlling means set forth in claims, and corresponds to a third transmission controlling step.

Then, in step S313, in the first Internet connecting device 103S on the sending party, the IP packet transmitted to the own side from the Internet 105 via the xDSL modem interface portion 203 is received, and then the IP packet processing portion 209 recognizes that the data in such IP packet are the Internet talking answer signal data that are sent from the second Internet connecting device 103R on the receiving party. Thus, the Internet talking between the sending party and the receiving party is established. Then, in step S314, in response to the Internet talking answer signal data that are sent from the second Internet connecting device 103R on the receiving party, the first Internet connecting device 103S on the sending party sends out the answer signal to the first analog telephone set 101S via the analog telephone interface portion 201. Also, in step S315, the first Internet connecting device 103S sends out the disconnect signal to the calling public telephone line network 107.

Then, in step S316, in the second Internet connecting device 103R on the receiving party, the disconnect signal transmitted from the first Internet connecting device 103S on the sending party via the public telephone line network 107 is received via the public telephone line network interface portion 205, and then is sensed by the overall controlling portion 225. Thus, the call issued from the sending party to the receiving party via the public telephone line network 107 is canceled.

Next, the voice talking executed via the Internet 105 will be explained with reference to FIG. 4 hereunder. In step S401, the voice signal is output from the first analog telephone set 101S on the sending party to the first Internet connecting device 103S. Then, in step S402, in the first Internet connecting device 103S, the A/D•D/A voice processing portion 207 A/D-converts the analog voice signal supplied from the first analog telephone set 101S and then converts the digital voice signal into the compressed voice signal data. Also, the IP packet processing portion 209 incorporates the compressed voice signal data received from the A/D•D/A voice processing portion 207 into the IP packet, and then sends out such IP packet to the Internet 105 via the xDSL modem interface portion 203. In this case, the receiver address of the IP packet is the IP address of the second Internet connecting device 103R on the receiving party, and the sender address is the IP address of the first Internet connecting device 103S on the sending party. The IP addresses saved in the destination-side IP address storing portion 219 and the own-side IP address storing portion 217 are used respectively.

Then, in step S403, in the second Internet connecting device 103R on the receiving party, the IP packet directed to the own side is received, and then the A/D•D/A voice processing portion 207 extracts the compressed voice signal data from the IP packet, then expands such compressed voice signal data, and then D/A-converts such digital voice signal into the analog voice signal. Then, in step S404, this analog voice signal is sent out to the second analog telephone set 101R on the receiving party via the analog telephone interface portion 201.

Then, the voice signal from the second analog telephone set 101R on the receiving party is also sent out to the first analog telephone set 101S via procedures in steps S406 to S409 that are similar to steps S401 to S404.

Next, procedures required until the voice talking via the Internet 105 is disconnected will be explained with reference to FIG. 5 hereunder. First, in step S501, in the first analog telephone set 101S on the sending party, when such telephone set 101S is put on the hook, the disconnect signal is sent out to the first Internet connecting device 103S. In step S502, in the first Internet connecting device 103S, when the overall controlling portion 225 senses the disconnect signal received via the analog telephone interface portion 201, the IP packet processing portion 209 loads the Internet talking end signal data into the data portion of the IP packet and then sends out such IP packet to the Internet 105 via the xDSL modem interface portion 203. In this case, the receiver address of the IP packet is the IP address of the second Internet connecting device 103R on the receiving party, and the sender address is the IP address of the first Internet connecting device 103S on the sending party. The IP addresses saved in the destination-side IP address storing portion 219 and the own-side IP address storing portion 217 are used respectively.

Then, in step S503, in the second Internet connecting device 103R on the receiving party, the IP packet directed to the own side is received, and then the IP packet processing portion 209 recognizes that the data portion of the IP packet is the Internet talking end signal data.

Then, in step S504, in the second Internet connecting device 103R that receives the Internet talking end signal data, the busy tone is sent out to the second analog telephone set 101R via the analog telephone interface portion 201 under control of the overall controlling portion 225. Also, in step S505, the IP packet processing portion 209 loads the Internet talking end answer signal data into the data portion of the IP packet and then sends out such IP packet to the Internet 105 via the xDSL modem interface portion 203. In this case, the receiver address of the IP packet is the IP address of the first Internet connecting device 103S on the sending party, and the sender address is the IP address of the second Internet connecting device 103R on the receiving party. The IP addresses saved in the destination-side IP address storing portion 219 and the own-side IP address storing portion 217 are used respectively.

Then, in step S506, in the second Internet connecting device 103R on the sending party, the IP packet directed to the own side is received, and then the IP packet processing portion 209 recognizes that the data portion of the IP packet is the Internet talking end answer signal data. Thus, the Internet talking is ended.

In addition, when the second analog telephone set 101R on the receiving party is put on the hook, the Internet talking is ended via the procedures in steps S511 to S516 that are similar to steps S501 to S506.

Next, procedures of switching the voice talking from the voice talking via the Internet 105 to the normal talking via the public telephone line network 107, which is initiated by the sending party, will be explained with reference to FIG. 6 hereunder.

First, in step S611 (S611 to S61N), the voice signal is output from the second analog telephone set 101R on the receiving party to the second Internet connecting. device 103R. Then, in step S621 (S621 to S62N), in the second Internet connecting device 103R, the analog voice signal is converted into the compressed voice signal data, and then is sent out to the Internet 105 as the IP packet. In this case, when the voice signal is formatted into the IP packet by the IP packet processing portion 209, the IP packets are numbered in order of transmission and then are sent out to the Internet 105 successively like step S621 to step S62N.

Then, in step S631 to step S63N, in the first Internet connecting device 103S on the sending party, the IP packet directed to the own side is received, and then the compressed voice signal data is extracted from the IP packet and then expanded into the analog voice signal. Then, in step S641 to S64N, this analog voice signal is sent out to the first analog telephone set 101S on the sending party via the analog telephone interface portion 201.

Here, in the first Internet connecting device 103S, when the IP packet directed to the own side is received in step S631, the timer portion 215 is caused to start under control of the overall controlling portion 225. In contrast, in the IP packet processing portion 209, the numbers assigned when the IP packet is formatted in the second Internet connecting device 103R are picked up from the received IP packet. Therefore, the Internet talking quality checking portion 211 counts sequentially the piece number of the serial number of the IP packet during when the timer portion 215 measures a predetermined time t, then compares such piece number with a predetermined number n, and then decides that the Internet talking quality is deteriorated in the case of “the IP packet number<n”.

The overall controlling portion 225 interrupts temporarily the Internet talking via the Internet 105 based on the decision of the Internet talking quality deterioration, and then starts the transition to the normal talking via the public telephone line network 107. In contrast, in the case of “the IP packet number>n”, the Internet talking quality is not deteriorated. Therefore, in this case, the Internet talking is continued and also the timer portion 215 is restarted.

As for the transition to the normal talking via the public telephone line network 107, in step S651, first the first Internet connecting device 103S reads the telephone number of the second analog telephone set 101R saved in the destination-side telephone number storing portion 223, then generates the DTMF signal by the DTMF signal sensing•generating/modem signal demodulating portion 213, and then dials the public telephone line network 107 via the public telephone line,network interface portion 205.

Then, in step S652, the dialing signal is received by the second Internet connecting device 103R on the receiving party via the public telephone line network 107. At this time, in the second Internet connecting device 103R, the calling signal issued from the public telephone line network 107 is received via the public telephone line network interface portion 205, then the modem signal is demodulated by the DTMF signal sensing•generating/modem signal demodulating portion 213 to sense the telephone number on the sending party, then such telephone number on the sending party is compared with the telephone number on the sending party saved in the destination-side telephone number storing portion 223, and then the Internet talking via the Internet 105 is switched into the normal talking via the public telephone line network 107 if both telephone numbers coincide with each other. On the contrary, unless both telephone numbers coincide with each other, the busy signal is sent out to the public telephone line network 107 via the public telephone line network interface portion 205.

If the talking is switched to the normal talking via the public telephone line network 107, in step S653, the second Internet connecting device 103R sends out the answer signal to the public telephone line network 107 via the public telephone line network interface portion 205, and then deals with the subsequent talking as the normal talking. In addition, in step S654, the first Internet connecting device 103S receives the answer signal from the public telephone line network 107 via the public telephone line network interface portion 205, and then deals with the subsequent talking as the normal talking.

Next, procedures of switching the voice talking from the normal talking via the public telephone line network 107 to the voice talking via the Internet 105, which is initiated by the sending party, will be explained with reference to FIG. 7 hereunder.

According to the procedures shown in FIG. 6, the switching of the voice talking from the voice talking via the Internet 105 to the normal talking via the public telephone line network 107, which is initiated by the sending party, is executed. At this time, in steps S711 to S71N, in the second Internet connecting device 103R on the receiving party, predetermined Internet talking quality check signal data are loaded into the IP packet and then are transmitted periodically to the first Internet connecting device 103S on the sending party. More particularly, the Internet talking quality check signal data are generated by the Internet talking quality checking portion 211, then such data are loaded into the data portion of the IP packet by the IP packet processing portion 209, and then the IP packet is sent out to the Internet 105 via the xDSL modem interface portion 203 by using the receiver address as the IP address of the first Internet connecting device 103S.

Then, in steps S721 to S72N, in the first Internet connecting device 103S on the sending party, the IP packet directed to the own side is received. In step S721, if it is recognized that the data in the IP packet is the Internet talking quality check signal data, the timer portion 215 is started under control of the overall controlling portion 225.

In contrast, in the IP packet processing portion 209, the number assigned when the IP packet is formatted in the second Internet connecting device 103R is picked up from the received IP packet. Therefore, the Internet talking quality checking portion 211 counts sequentially the piece number of the serial number of the IP packet during when the predetermined time t is measured by the timer portion 215, then compares the piece number with the predetermined number n, and then decides that the Internet talking quality is improved in the case of “the IP packet number>n”.

The overall controlling portion 225 disconnects the normal talking via the public telephone line network 107 based on the decision of the Internet talking quality improvement, and then starts the transition to the Internet talking via the Internet 105. In contrast, in the case of “the IP packet number<n”, the Internet talking quality is still deteriorated. Therefore, in this case the normal talking is continued, and the timer portion 215 is restarted.

As for the transition to the Internet talking via the Internet 105, in step S731, in the first Internet connecting device 103S on the sending party, first the Internet talking restart signal data are generated by the Internet talking quality checking portion 211, then such data are loaded into the data portion of the IP packet by the IP packet processing portion 209, and then such IP packet is sent out to the Internet 105 via the xDSL modem interface portion 203 by using the receiver address as the IP address of the second Internet connecting device 103R.

Then, in step S732, in the second Internet connecting device 103R on the receiving party, the IP packet that is transmitted to the own side from the Internet 105 via the xDSL modem interface portion 203 is received, and then the transition to the Internet talking is started if it is decided by the IP packet processing portion 209 that such data are the Internet talking restart signal data transmitted from the first Internet connecting device 103S on the sending party.

Also, in step S733, in the first Internet connecting device 103S on the sending party, the disconnect signal is sent out to the public telephone line network 107 via the analog telephone interface portion 201. In this case, the subsequent talking is treated as the Internet talking and the callings except the calling issued from the other party of the talking are rejected, and then the busy tone is sent out to the public telephone line network 107 via the analog telephone interface portion 201.

Then, in step S734, in the second Internet connecting device 103R on the receiving party, the disconnect signal sent from the first Internet connecting device 103S on the sending party via the public telephone line network 107 is received via the public telephone line network interface portion 205, then such disconnect signal is sensed by the overall controlling portion 225, and then the subsequent talking is treated as the Internet talking. In this case, the callings except the calling issued from the other party of the talking are rejected, and then the busy tone is sent out to the public telephone line network 107 via the analog telephone interface portion 201.

Then, in step S735, in the second Internet connecting device 103R on the receiving party, when the overall controlling portion 225 senses the disconnect signal from the public telephone line network 107, such overall controlling portion 225 sends out the on-hook signal to the public telephone line network 107 via the public telephone line network interface portion 205 and then terminates the normal taking via the public telephone line network 107.

Next, procedures of switching the voice talking from the voice talking via the Internet 105 to the normal talking via the public telephone line network 107, which is initiated by the receiving party, will be explained with reference to FIG. 8 hereunder.

First, in step S811 (S811 to S81N), the voice signal is output from the first analog telephone set 101S on the sending party to the first Internet connecting device 103S. Then, in step S821 (S821 to S82N), in the first Internet connecting device 103S, the analog voice signal is converted into the compressed voice signal data, and then such signal is sent out to the Internet 105 as the IP packet. In this case, the IP packets are numbered in order of transmission when the voice signal is loaded into the IP packet by the IP packet processing portion 209, and then are sequentially sent out to the Internet 105 in step S821 to step S82N.

Then, in steps S831 to S83N, in the second Internet connecting device 103R on the receiving party, the IP packet directed to the own side is received, then the compressed voice signal data are taken out from the IP packet, then such compressed voice signal data are expanded to the digital voice signal, and then such digital voice signal is converted into the analog voice signal. Then, in steps S841 to S84N, such analog voice signal is sent out to the second analog telephone set 101R on the receiving party via the analog telephone interface portion 201.

Here, in the second Internet connecting device 103R, when the IP packet directed to the own side is received in step S831, the timer portion 215 is caused to start under control of the overall controlling portion 225. In contrast, in the IP packet processing portion 209, the numbers assigned when the IP packet is formatted in the first Internet connecting device 103S are picked up from the received IP packet. Therefore, the Internet talking quality checking portion 211 counts sequentially the piece number of the serial number of the IP packet during when the timer portion 215 measures the predetermined time t, then compares such piece number with the predetermined number n, and then decides that the Internet talking quality is deteriorated in the case of “the IP packet number<n”.

The overall controlling portion 225 interrupts temporarily the Internet talking via the Internet 105 based on the decision of the Internet talking quality deterioration, and then starts the transition to the normal talking via the public telephone line network 107. In contrast, in the case of “the IP packet number>n”, the Internet talking quality is not deteriorated. Therefore, in this case, the Internet talking is continued and also the timer portion 215 is restarted.

As for the transition to the normal talking via the public telephone line network 107, in step S851, first, in the second Internet connecting device 103R, the Internet talking temporary interrupt signal data are generated by the Internet talking quality checking portion 211, then such data are loaded into the data portion of the IP packet by the IP packet processing portion 209, and then the IP packet is sent out to the Internet 105 via the xDSL modem interface portion 203 by using the receiver address as the IP address of the first Internet connecting device 103S.

Then, in step S852, in the first Internet connecting device 103S on the sending party, the IP packet transmitted to the own side from the Internet 105 via the xDSL modem interface portion 203 is received, and then the transition to the normal talking is started if it is decided by the IP packet processing portion 209 that such data are the Internet talking temporary interrupt signal data from the second Internet connecting device 103R on the receiving party.

Then, in step S853, in the first Internet connecting device 103S on the sending party, the telephone number of the second analog telephone set 101R saved in the destination-side telephone number storing portion 223 is read, then the DTMF signal is generated by the DTMF signal sensing•generating/modem signal demodulating portion 213, and then the public telephone line network 107 is dialed via the public telephone line network interface portion 205.

Then, in step S854, the calling signal is received by the second Internet connecting device 103R on the receiving party via the public telephone line network 107. At this time, in the second Internet connecting device 103R, the modem signal issued from the public telephone line network 107 is received via the public telephone line network interface portion 205, then the modem signal is demodulated by the DTMF signal sensing•generating/modem signal demodulating portion 213 to sense the telephone number on the sending party, then such telephone number on the sending party is compared with the telephone number on the sending party saved in the destination-side telephone number storing portion 223, and then the Internet talking via the Internet 105 is switched into the normal talking via the public telephone line network 107 if both telephone numbers coincide with each other. On the contrary, unless both telephone numbers coincide with each other, the busy tone is sent out to the public telephone line network 107 via the public telephone line network interface portion 205.

If the talking is switched to the normal talking via the public telephone line network 107, in step S855, the second Internet connecting device 103R sends out the answer signal to the public telephone line network 107 via the public telephone line network interface portion 205, and then deals with the subsequent talking as the normal talking. In addition, in step S856, the first Internet connecting device 103S receives the answer signal from the public telephone line network 107 via the public telephone line network interface portion 205, and then deals with the subsequent talking as the normal talking.

Next, procedures of switching the voice talking from the normal talking via the public telephone line network 107 to the voice talking via the Internet 105, which is initiated by the receiving party, will be explained with reference to FIG. 9 hereunder.

According to the procedures shown in FIG. 8, the switching of the voice talking from the voice talking via the Internet 105 to the normal talking via the public telephone line network 107, which is initiated by the receiving party, is executed. At this time, in steps S911 to S91N, in the first Internet connecting device 103S on the sending party, the predetermined Internet talking quality check signal data are loaded into the IP packet and then are transmitted periodically to the second Internet connecting device 103R on the receiving party. More particularly, the Internet talking quality check signal data are generated by the Internet talking quality checking portion 211, then such data are loaded into the data portion of the IP packet by the IP packet processing portion 209, and then the IP packet is sent out to the Internet 105 via the xDSL modem interface portion 203 by using the receiver address as the IP address of the second Internet connecting device 103R.

Then, in steps S921 to S92N, in the second Internet connecting device 103R on the receiving party, the IP packet directed to the own side is received. In step S921, if it is recognized that the data in the IP packet is the Internet talking quality check signal data, the timer portion 215 is started under control of the overall controlling portion 225.

In contrast, in the IP packet processing portion 209, the number assigned when the IP packet is formatted in the first Internet connecting device 103S is taken out from the received IP packet. Therefore, the Internet talking quality checking portion 211 counts sequentially the piece number of the serial number of the IP packets during when the predetermined time t is measured by the timer portion 215, then compares the piece number with the predetermined number n, and then decides that the Internet talking quality is improved in the case of “the IP packet number>n”.

The overall controlling portion 225 disconnects the normal talking via the public telephone line network 107 based on the decision of the Internet talking quality improvement, and then starts the transition to the Internet talking via the Internet 105. In contrast, in the case of “the IP packet number<n”, the Internet talking quality is still deteriorated. Therefore, in this case, the normal talking is continued, and the timer portion 215 is restarted.

As for the transition to the Internet talking via the Internet 105, in step S931, in the second Internet connecting device 103R on the sending party, first the Internet talking restart signal data are generated by the Internet talking quality checking portion 211, then such data are loaded into the data portion of the IP packet by the IP packet processing portion 209, and then such IP packet is sent out to the Internet 105 via the xDSL modem interface portion 203 by using the receiver address as the IP address of the first Internet connecting device 103S.

Then, in step S932, in the first Internet connecting device 103S on the sending party, the IP packet that is transmitted to the own side from the Internet 105 via the xDSL modem interface portion 203 is received, and then the transition to the Internet talking is started if it is decided by the IP packet processing portion 209 that such data are the Internet talking restart signal data sent from the second Internet connecting device 103R on the receiving party.

Also, in step S933, in the first Internet connecting device 103S on the sending party, the disconnect signal is sent out to the public telephone line network 107 via the public telephone line network interface portion 205. In this case, the subsequent talking is treated as the Internet talking and the callings except the calling issued from the other party of the talking are rejected, and then the busy tone is sent out to the public telephone line network 107 via the public telephone line network interface portion 205.

Then, in step S934, in the second Internet connecting device 103R on the receiving party, the disconnect signal sent from the first Internet connecting device 103S on the sending party via the public telephone line network 107 is received via the public telephone line network interface portion 205, then such disconnect signal is sensed by the overall controlling portion 225, and then the subsequent talking is treated as the Internet talking. In this case, the callings except the calling issued from the other party of the talking are rejected, and then the busy tone is sent out to the public telephone line network 107 via the public telephone line network interface portion 205.

Then, in step S935, in the second Internet connecting device 103R on the receiving party, when the overall controlling portion 225 senses the disconnect signal from the public telephone line network 107, such overall controlling portion 225 sends out the on-hook signal to the public telephone line network 107 via the public telephone line network interface portion 205 and then terminates the normal taking via the public telephone line network 107.

As described above, the network connecting devices 103S, 103R, the communication system, and the communication method according to the present embodiment, in the first Internet connecting device 103S, the telephone number of the first analog telephone set 101S is stored in the own-side telephone number storing portion 221 (by the own-side telephone number storing step), and the telephone number of the second analog telephone set 101R is saved in the destination-side telephone number storing portion 223 (by the destination-side telephone number storing step) at the time of dial-up by the first analog telephone set 101S by utilizing the public telephone line network 107. In contrast, in the first Internet connecting device 103S, the telephone number of the second analog telephone set 101R is stored in the own-side telephone number storing portion 221 (by the own-side telephone number storing step), and the telephone number of the first analog telephone set 101S is saved in the destination-side telephone number storing portion 223 (by the destination-side telephone number storing step) at the time of receiving the call from the first Internet connecting device 103S (the first analog telephone set 101S). Also, the IP packet containing the predetermined multicast address as the receiver address, the IP address of the second Internet connecting device 103R as the sender address, and the telephone numbers saved in the own-side telephone number storing portion 221 and the destination-side telephone number storing portion 223 as the data is transmitted to the Internet 105 from the IP packet processing portion 209 (the broadcast controlling step) via the xDSL modem interface portion 203 under control of the overall controlling portion 225.

Next, in the first Internet connecting device 103S, the IP packet being multicast-transmitted from the second Internet connecting device 103R via the xDSL modem interface portion 203 (by the first reception controlling step) is received after the dialing signal is issued by utilizing the public telephone line network 107, then the telephone number in the IP packet is compared with the telephone numbers saved in the own-side telephone number storing portion 221 and the destination-side telephone number storing portion 223 respectively, and then the sender address in the IP packet is saved in the destination-side IP address storing portion 219 (by the destination-side network address storing step) if both telephone numbers coincide with each other in such comparison. Also, if both telephone numbers coincide with each other in such comparison, the IP packet containing the address saved in the destination-side IP address storing portion 219 as the receiver address, the IP address of the first Internet connecting device 103S as the sender address, and the telephone numbers saved in the own-side telephone number storing portion 221 and the destination-side telephone number storing portion 223 as the data is sent out from the IP packet processing portion 209 (by the second transmission controlling step) to the Internet 105 via the xDSL modem interface portion 203 under control of the overall controlling portion 225. Also, the public telephone line network 107 that is now called is released.

Next, after the IP packet is multicast-transmitted in the second Internet connecting device 103R or after the IP packet is transmitted in the first Internet connecting device 103S, the IP packet transmitted from the network connecting device on the other party is received by the IP packet processing portion 209 (by the second reception controlling step) under control of the overall controlling portion 225 respectively, and then the telephone number in the IP packet is compared with the telephone numbers saved in the own-side telephone number storing portion 221 and the destination-side telephone number storing portion 223 respectively. Then, if both telephone numbers coincide with each other in such comparison, the IP packet containing the address saved in the destination-side IP address storing portion 219 as the receiver address, the IP address of the second Internet connecting device 103R or the first Internet connecting device 103S as the sender address, and the telephone numbers and the voice data saved in the own-side telephone number storing portion 221 and the destination-side telephone number storing portion 223 as the data is transmitted from the IP packet processing portion 209 (by the third transmission controlling step) to the Internet 105 under control of the overall controlling portion 225. In this case, in the second Internet connecting device 103R, if both telephone numbers coincide with each other in such comparison, the sender address in the IP packet is saved in the destination-side IP address storing portion 219 (by the destination-side network address storing step).

In the following, the voice talking via the Internet 105 is carried out by transmitting the IP packet (by the third transmission controlling step) while checking the telephone number in the received IP packet (by the second reception controlling step). In this manner, the voice talking via the Internet 105 can be carried out by transmitting/receiving the IP packet by virtue of the xDSL communication using the TCP/IP protocol. Thus, the talking can be carried out by the Internet phone system that needs a lower communication cost. Also, the low-cost Internet phone system can be built up with a simpler means construction.

Also, in the present embodiment, the piece number of the serial number of the IP packets being received within the predetermined time is counted by the Internet talking quality checking portion 211 (by the first switching controlling step) during when the voice talking by utilizing the Internet 105 is carried out. Then, if the counted number is lower than the predetermined value, the voice talking via the Internet 105 is switched to the voice talking by utilizing the public telephone line network 107.

In this manner, in the voice talking utilizing the Internet 105, the deterioration of the voice quality is decided by the number of the IP packets being received within the predetermined time, and then such voice talking utilizing the Internet 105 is switched automatically into the voice talking by utilizing the public telephone line network 107 if the voice quality is deteriorated.

Therefore, even if the voice quality is lowered, e.g., disconnection, omission, etc. of the conversation are caused according to the situation, the voice quality at the time of talking can be maintained by switching the voice talking into the normal voice talking utilizing the public telephone line network 107.

Also, after the voice talking is switched from the voice talking utilizing the Internet 105 to the voice talking utilizing the public telephone line network 107, the IP packet containing the address saved in the destination-side IP address storing portion 219 as the receiver address, the IP address of the first Internet connecting device 103S or the second Internet connecting device 103R as the sender address, and the number assigned in order of transmission as the data is transmitted periodically to the Internet 105 by the Internet talking quality checking portion 211 and the IP packet processing portion 209 (by the fourth transmission controlling step). In the second Internet connecting device 103R or the first Internet connecting device 103S, the IP packet being transmitted periodically from the network connecting device on the other party is received by the Internet talking quality checking portion 211 and the IP packet processing portion 209 (by the second switching controlling step), then the piece number of the serial number of the IP packets is counted within the predetermined time, and then the voice talking is switched into the voice talking utilizing the Internet 105 if the counted number is in excess of the predetermined value.

In this fashion, after the voice talking is switched into the voice talking utilizing the public telephone line network 107, the quality checking data block is transmitted/received periodically, and then improvement of the voice quality in the Internet 105 is decided based on the number of the IP packets received within the predetermined time. Then, if it is decided that the voice quality is improved, the voice talking is switched automatically into the voice talking utilizing the Internet 105. Therefore, the voice talking utilizing the Internet 105, which has a lower communication cost, can be carried out preferentially while maintaining the voice quality at the time of taking.

The present invention is explained in detail with reference to: particular embodiments. But it is obvious to the person skilled in the art that various variations and modifications can be applied without departing from the spirit and the scope of the present invention.

The present application is made based on Japanese Patent Application (Patent Application No. 2001-280068) filed on Sep. 14, 2001 and the contents are incorporated herein by the reference.

### Industrial Applicability

As described above, according to the network connecting device, the communication system, the communication method, the communication program, and the recording medium of the present invention, in one (first) network connecting device, the telephone number of the destination-side (second) analog telephone set is saved by the destination-side telephone number storing means (by the destination-side telephone number storing step) at the time of dial-up by the (first) analog telephone set by utilizing the public telephone line network. In contrast, in the other (second) network connecting device, the telephone number of the (first) telephone set is saved by the destination-side telephone number storing means (by the destination-side telephone number storing step) at the time of receiving the call from the (first) telephone set belonging to the (first) network connecting device. Also, the first data block containing the predetermined multicast address as the receiver address, the network address of the (second) network connecting device as the sender address, and the telephone numbers saved in the own-side telephone number storing means and the destination-side telephone number storing means as the data is multicast-transmitted to the second network by the broadcast controlling means (by the broadcast controlling step).

Next, in the (first) network connecting device, the first data block being multicast-transmitted from the other (second) network connecting device by first reception controlling means (by the first reception controlling step) is received after the dialing signal is issued by utilizing the public telephone line network, and then the telephone number in the first data block is compared with the telephone numbers saved in the own-side telephone number storing means and the destination-side telephone number storing means respectively. Then, if both telephone numbers coincide with each other in such comparison, the sender address in the first data block is saved by the destination-side network address storing means (by the destination-side network address storing step), and then the second data block containing the address saved in the destination-side network address storing means as the receiver address, the network address of the (first) network connecting device as the sender address, and the telephone numbers saved in the own-side telephone number storing means and the destination-side telephone number storing means as the data is sent out to the second network by the second transmission controlling means (by the second transmission controlling step), and also the public telephone line network that is now called is released. Subsequently, the data block is transmitted by the third transmission controlling means (by the third transmission controlling step) while checking the telephone number in the received data block by the second reception controlling means (by the second reception controlling step). In this manner, since the voice talking via the second network can be carried out, the Internet phone system that can reduce much more a communication cost can be constructed and also the low-cost Internet phone system can be built up with a simpler means construction.

Also, according to the present invention, in the voice talking utilizing the second network, the deterioration of the voice quality is decided by the number of the data blocks being received within the predetermined time, and then such voice talking utilizing the second network is switched automatically into the voice talking by utilizing the public telephone line network if the voice quality is deteriorated. Therefore, even if the voice quality is lowered, the voice quality in the talking can be maintained by switching the voice talking into the normal voice talking utilizing the public telephone line network.

In addition, after the voice talking is switched into the voice talking utilizing the public telephone line network, the quality checking data block is transmitted/received periodically, and then improvement of the voice quality in the second network is decided based on the number of the data blocks received within the predetermined time. Then, if it is decided that the voice quality is improved, the voice talking is switched automatically into the voice talking utilizing the second network. Therefore, the voice talking utilizing the second network, which has a lower communication cost, can be carried out preferentially while maintaining the voice quality in the taking.

1. A network connecting device connected to a public telephone line network and a second network to control a talking connection executed between a telephone set belonging to the network connecting device and another telephone set belonging to another network connecting device via the public telephone line network or the second network, comprising:
an own-side telephone number storing means for storing a telephone number of the telephone set belonging to the network connecting device;
a destination-side telephone number storing means for saving a telephone number of a destination-side telephone set when a dialing signal is issued by the telephone set belonging to the network connecting device utilizing the public telephone line network or when an incoming call issued from another telephone set belonging to another network connecting device is sensed;
a broadcast controlling means for broadcasting a first data block, which contains a predetermined broadcast address as a receiver address, a network address of the network connecting device as a sender address, and telephone numbers saved in the own-side telephone number storing means and the destination-side telephone number storing means as data, to the second network when the incoming call issued from another telephone set belonging to another network connecting device is sensed;
a first reception controlling means for receiving the first data block being broadcasted from another network connecting device after the dialing signal is issued by utilizing the public telephone line network, and then comparing the telephone number in the first data block with the telephone numbers saved in the own-side telephone number storing means and the destination-side telephone number storing means respectively;
a destination-side network address storing means for saving the sender address in the first data block when both telephone numbers coincide with each other respectively in comparison executed by the first reception controlling means;
a second transmission controlling means for transmitting a second data block, which contains an address saved in the destination-side network address storing means as the receiver address, a network address of the network connecting device as the sender address, and the telephone numbers saved in the own-side telephone number storing means and the destination-side telephone number storing means as data, to the second network and also releasing the public telephone line network that is now called when both telephone numbers coincide with each other in comparison executed by the first reception controlling means;
a second reception controlling means for receiving a data block transmitted from another network connecting device after broadcast is executed by the broadcast controlling means or after transmission is executed by the second transmission controlling means, and then comparing the telephone number in the data bock with the telephone numbers saved in the own-side telephone number storing means and the destination-side telephone number storing means respectively; and
a third transmission controlling means for transmitting a data block, which contains an address saved in the destination-side network address storing means as the receiver address, a network address of the network connecting device as the sender address, and the telephone numbers saved in the own-side telephone number storing means and the destination-side telephone number storing means and voice data as data, to the second network when both telephone numbers coincide with each other respectively in comparison executed by the second reception controlling means.

2. The network connecting device according to claim 1,
wherein the data block being transmitted from the third transmission controlling means contains a number that is assigned in order of transmission, and
said network connecting device further comprising:
a first switching controlling means for counting a piece number of a serial number of the data block received within a predetermined time at a time of voice talking utilizing the second network, and then the voice talking is switched into a voice talking utilizing the public telephone line network when a counted number is smaller than a predetermined value.

3. The network connecting device according to claim 2, further comprising:
a fourth transmission controlling means for transmitting periodically a third data block, which contains the address saved in the destination-side network address storing means as the receiver address, the network address of the network connecting device as the sender address, and the number being assigned in order of transmission as data, to the second network after the voice talking is switched from the voice talking utilizing the second network into the voice talking utilizing the public telephone line network by the first switching controlling means; and
a second switching controlling means for receiving the third data block being transmitted periodically from the fourth transmission controlling means in another network connecting device, then counting the piece number of the serial number of the third data block received within a predetermined time, and then switching the voice talking into the voice talking utilizing the second network if a counted number is in excess of a predetermined value.

4. A communication system comprising:
a first network connecting device and a second network connecting device connected to a public telephone line network and a second network;
a first telephone set belonging to the first network connecting device; and
a second telephone set belonging to the second network,
wherein the first network connecting device includes:
an own-side telephone number storing means for saving a telephone number of the first telephone set;
a destination-side telephone number storing means for saving a telephone number of a destination-side telephone set when a dialing signal is issued by the first telephone set utilizing the public telephone line network;
a first reception controlling means for receiving the first data block being broadcasted from the second network connecting device after the dialing signal is issued by utilizing the public telephone line network, and then comparing the telephone number in the first data block with telephone numbers saved in the own-side telephone number storing means and the destination-side telephone number storing means respectively;
a destination-side network address storing means for saving a sender address in the first data block when both telephone numbers coincide with each other respectively in comparison executed by the first reception controlling means;
a second transmission controlling means for transmitting a second data block, which contains an address saved in the destination-side network address storing means as the receiver address, a network address of the first network connecting device as the sender address, and the telephone numbers saved in the own-side telephone number storing means and the destination-side telephone number storing means as data, to the second network and also releasing the public telephone line network that is now called when both telephone numbers coincide with each other in comparison executed by the first reception controlling means;
a second reception controlling means for receiving a data block transmitted from the second network connecting device after transmission is executed by the second transmission controlling means, and then comparing the telephone number in the data bock with the telephone numbers saved in the own-side telephone number storing means and the destination-side telephone number storing means respectively; and
a third transmission controlling means for transmitting a data block, which contains an address saved in the destination-side network address storing means as the receiver address, a network address of the first network connecting device as the sender address, and the telephone numbers saved in the own-side telephone number storing means and the destination-side telephone number storing means and voice data as data, to the second network when both telephone numbers coincide with each other respectively in comparison executed by the second reception controlling means; and
wherein the second network connecting device includes:
an own-side telephone number storing means for saving a telephone number of the second telephone set;
a destination-side telephone number storing means for saving a telephone number of the first telephone set when an incoming call issued from the first telephone set belonging to the first network connecting device is sensed;
a broadcast controlling means for broadcasting a first data block, which contains a predetermined broadcast address as a receiver address, a network address of the second network connecting device as a sender address, and the telephone numbers saved in the own-side telephone number storing means and the destination-side telephone number storing means as data, to the second network when the incoming call issued from the first telephone set belonging to the first network connecting device is sensed;
a second reception controlling means for receiving the data block being transmitted from the first network connecting device after broadcast is executed by the broadcast controlling means, and then comparing the telephone number in the data block with the telephone numbers saved in the own-side telephone number storing means and the destination-side telephone number storing means respectively;
a destination-side network address storing means for saving the sender address in the first data block when both telephone numbers coincide with each other respectively in comparison executed by the first reception controlling means; and
a third transmission controlling means for transmitting a data block, which contains an address saved in the destination-side network address storing means as the receiver address, a network address of the network connecting device as the sender address, and the telephone numbers saved in the own-side telephone number storing means and the destination-side telephone number storing means and voice data as data, to the second network when both telephone numbers coincide with each other respectively in comparison executed by the second reception controlling means.

5. A communication method for a communication system having a first network connecting device and a second network connecting device connected to a public telephone line network and a second network, a first telephone set belonging to the first network connecting device, and a second telephone set belonging to the second network, said method comprising:
at the first network connecting device,
an own-side telephone number storing step of storing a telephone number of the first telephone set; a destination-side telephone number storing step of storing a telephone number of a destination-side telephone set when a dialing signal is issued by the first telephone set utilizing the public telephone line network;
a first reception controlling step of receiving the first data block being broadcasted from the second network connecting device after the dialing signal is issued by utilizing the public telephone line network, and then comparing the telephone number in the first data block with telephone numbers stored by the own-side telephone number storing step and the destination-side telephone number storing step respectively;
a destination-side network address storing step of storing a sender address in the first data block when both telephone numbers coincide with each other respectively in comparison executed by the first reception controlling step;
a second transmission controlling step of transmitting a second data block, which contains an address stored by the destination-side network address storing step as the receiver address, a network address of the first network connecting device as the sender address, and the telephone numbers stored by the own-side telephone number storing step and the destination-side telephone number storing step as data, to the second network and also releasing the public telephone line network that is now called when both telephone numbers coincide with each other in comparison executed by the first reception controlling step;
a second reception controlling step of receiving a data block transmitted from the second network connecting device after transmission is executed by the second transmission controlling step, and then comparing the telephone number in the data bock with the telephone numbers stored by the own-side telephone number storing step and the destination-side telephone number storing step respectively; and
a third transmission controlling step of transmitting a data block, which contains an address stored by the destination-side network address storing step as the receiver address, a network address of the first network connecting device as the sender address, and the telephone numbers stored by the own-side telephone number storing step and the destination-side telephone number storing step and voice data as data, to the second network when both telephone numbers coincide with each other respectively in comparison executed by the second reception controlling step; and
at the second network connecting device,
an own-side telephone number storing step of storing a telephone number of the second telephone set; a destination-side telephone number storing step of storing a telephone number of the first telephone set when an incoming call issued from the first telephone set belonging to the first network connecting device is sensed;
a broadcast controlling step of broadcasting a first data block, which contains a predetermined broadcast address as the receiver address, a network address of the second network connecting device as the sender address, and the telephone numbers stored by the own-side telephone number storing step and the destination-side telephone number storing step as data, to the second network when the incoming call issued from the first telephone set belonging to the first network connecting device is sensed;
a second reception controlling step of receiving the data block being transmitted from the first network connecting device after broadcast is executed by the broadcast controlling step, and then comparing the telephone number in the data block with the telephone numbers stored by the own-side telephone number storing step and the destination-side telephone number storing step respectively;
a destination-side network address storing step of storing the sender address in the data block when both telephone numbers coincide with each other respectively in comparison executed by the second reception controlling step; and
a third transmission controlling step of transmitting a data block, which contains an address stored in the destination-side network address storing step as the receiver address, a network address of the second network connecting device as the sender address, and the telephone numbers stored by the own-side telephone number storing step and the destination-side telephone number storing step and the voice data as data, to the second network when both telephone numbers coincide with each other respectively in comparison executed by the second reception controlling step.

6. A communication program used to cause a computer to execute the communication method set forth in claim 5.

7. A computer-readable recording medium for recording the communication method set forth in claim 5 as a program that is used to cause a computer to execute the communication method.
